(19) United States
(12) Patent Application Publication
(10) Pub. No.: US 2025/0316717 A1
(43) Pub. Date: Oct. 9, 2025

(54) BIFUNCTIONAL ELECTROCATALYST FOR ALL-SOLID-STATE RECHARGEABLE ZINC-AIR BATTERY

(71) Applicant: COUNCIL OF SCIENTIFIC AND INDUSTRIAL RESEARCH, New Delhi (IN)

(72) Inventors: Narugopal Manna, Maharashtra Pune (IN); Sreekumar Kurungot, Maharashtra Pune (IN)

(21) Appl. No.: 18/866,450

(22) PCT Filed: May 16, 2023
(86) PCT No.: PCT/IN2023/050458

§ 371 Date: Nov. 15, 2024

(30) Foreign Application Priority Data
May 17, 2022 (IN) 202211028438

(51) Int. Cl. H01M 4/90; H01M 4/88; H01M 12/06

(52) U.S. Cl. CPC H01M 4/9016; H01M 4/8807; H01M 4/8842; H01M 12/06

(57) ABSTRACT

The present invention discloses an electrocatalyst for bifunctional oxygen reaction at the air cathode interface comprising manganese-cobalt-based bimetallic spinel oxide deposited on N-doped 3D porous entangled graphene (NEGF). The invention further provides fabricated all-solid-state rechargeable zinc-air batteries (ZABs) comprising said electrocatalyst coated air cathode that delivers a higher power density with stable cyclic stability.

### FIELD OF THE INVENTION

The present invention relates to a bifunctional electrocatalyst for all-solid-state rechargeable zinc-air battery. In particular, the present invention relates to an electrocatalyst for bifunctional oxygen reaction at the air cathode interface comprising manganese-cobalt-based bimetallic spinel oxide deposited on N-doped 3D porous entangled graphene (NEGF). The invention further provides fabricated all-solid-state rechargeable zinc-air batteries (ZABs) comprising said electrocatalyst coated air cathode that delivers a higher power density with stable cyclic stability. The invention finds immense application in the field of energy storage, particularly mobile as well stationery (also renewable) applications. The invention shall help attain the 7^{th} sustainable development goal of affordable and clean energy.

### BACKGROUND AND PRIOR ART OF THE INVENTION

The all-solid-state rechargeable zinc-air batteries (ZABs) have gained appreciable interest for large-scale energy storage applications in portable electronic devices in order to address future energy and environmental challenges. The Li-air batteries are known but have safety considerations and Li abundance is low which escalates the cost of Li-air batteries. The abundance and availability of zinc is one reason for the popularity of zinc-air batteries. Moreover, the all-solid-state rechargeable ZABs have several advantages over existing metal-air batteries such as high theoretical energy density and use of safe aqueous electrolyte. The practical applications of ZABs are however impoverished by their low power density, deficient charge-discharge voltage, and overall lower output energy efficiency. These limitations are mainly attributed to the slow kinetics of oxygen reduction reaction (ORR) and oxygen evolution reaction (OER) on the air cathode.

Conventionally, the spherical-shaped platinum nanoparticles supported by carbon (Pt/C) and RuO₂ are mostly used as electrocatalysts for ORR and OER processes in ZABs but they are costly and not durable. The major obstacle with the air cathode in the ZABs is the restricted mass transport of reactant/products gas molecules and electrolytes due to the comparatively lower access of active sites and imbalanced hydrophilicity/hydrophobicity of the electrocatalyst-coated gas diffusion layer (GDL) interface.

In order to develop high-performance air electrode catalysts, a series of non-noble metal-based catalytic materials with excellent intrinsic activities are reported (e.g., transition metal oxides/hydroxides/chalcogenides/heteroatom doped carbon-based materials and hybrids of these materials) in the art. Among them, the transition metal oxides (Fe, Co, Mn, Ni) have received enormous attention as ORR/OER electrocatalysts due to their ease of synthesis, stability, and structural flexibility.

Spinel oxides (A^{II}B^{II}B^{III}O₄) are mostly being explored as an electrocatalyst, in which mixed-valence metal ions are distributed in octahedral and tetrahedral sites, respectively. The mixed valency metal ions in a spinel oxide crystal structure provide a preferable electron transport channel improving the electrochemical activity [Zang, M.; Xu, N. et.al; ACS Catal. 2018, 8, 5062-5069]. Recently, the present inventors have reported the nano-rod-shaped spinel cobalt oxides with promising ORR performance [Manna, et.al in Zinc-Air Batteries Catalyzed Using CO₃O₄ Nanorod-Supported N-Doped Entangled Graphene for Oxygen Reduction Reaction. ACS Appl. Energy Mater. 2021, 4, 5, 4570-4580]. To overcome the electronic conductivity issue of the metal oxide catalysts, carbon support incorporation as active sites have been adopted, this simultaneously prevents the aggregation of nanoparticles. Most of the conducting carbon support used for the spinel oxides support are 1D and 2D materials with poorly established triple phase boundaries (TPB) at the electrochemical interface.

Regardless of the importance of TPB in the electrocatalyst, the interfacial engineering in rechargeable ZAB's air cathodes has received diminutive attention. Although significant research has been done on conventional air cathode fabrication by metal-oxide carbon composite-based bifunctional catalyst layer on the surface of a hydrophobic gas diffusion electrode (GDL, this air cathode structure provides an almost 2D multiphase interface that is confined to the limited space between the porous GDL and electrocatalyst layer. In this configuration, most of the electrolytes and gaseous reactants cannot reach out to the catalytic sites. Thus, the traditional air cathode structure in ZABs inevitably gives rise to sluggish reaction kinetics for ORR and OER, which significantly reduces the ZAB performance. Thus air-cathode interface engineering with good balance between hydrophobicity& hydrophilicity is vital for better mass transport.

Accordingly, keeping in view the drawbacks of the hitherto reported prior art, the inventors of the present invention realized that there exists a dire need to improve intrinsic bifunctional activity of spinel oxides, which can be done by way of providing an electrocatalyst for bifunctional oxygen reaction at the air cathode interface comprising manganese-cobalt-based bimetallic spinel oxide, wherein the intrinsic bi-functional activity of spinel oxides has been improved by morphology and compositional tuning.

### OBJECTIVES OF THE INVENTION

The main objective of the present invention is therefore to provide an electrocatalyst for bifunctional oxygen reaction at the air cathode interface comprising manganese-cobalt-based bimetallic spinel oxide deposited on N-doped 3D porous graphene (NEGF) and solvothermal preparation process thereof.

Another objective of the present invention is to provide all-solid-state rechargeable zinc-air batteries (ZABs) comprising said electrocatalyst coated air cathode that delivers a higher power density with stable cyclic stability.

### SUMMARY OF THE INVENTION

In an aspect, the present invention provides an electrocatalyst for bifunctional oxygen reaction at the air cathode interface comprising manganese-cobalt-based bimetallic spinel oxide deposited on N-doped 3D porous entangled graphene (NEGF).

Preferably, the present invention provides MnCo₂O₄/3D NGr electrocatalyst which represents the self-assembly structure of nitrogen-doped three-dimensionally oriented graphene. The MnCo₂O₄ is uniformly distributed over the N-doped 3D graphene.

In an aspect, the MnCo₂O₄ is spherical in shape with the size ranging between 30-60 nm.

In another aspect, the pore size of MnCo₂O₄/NEGF catalytic material ranges between 2-16 nm; and has a BET surface area in the range of 300-320 m²g⁻¹.

In another aspect, the present invention provides solvothermal process for synthesis of said electrocatalysts (MnCo₂O₄/3D NGr) as coated material on air cathode, process comprising;
(i) dispersing the graphene oxide (GO) synthesized via improved Hummer's method in water and ammonia solution (30% v/v) to obtain viscous graphene oxide solution;
(ii) adding Co²⁺ and Mn²⁺ metal salts to the viscous graphene oxide solution of step (i) in 2:1 ratio at constant stirring followed by probe sonication;
(iii) transferring the solution of step (ii) to a Teflon-lined autoclave and heating followed by cooling and washing to remove excess ammonia;
(iv) freeze-drying the mixture of step (iii) under high vacuum pressure to obtain the desired electrocatalyst.

In another preferred aspect, the present invention provides an all-solid-state rechargeable zinc-air battery (ZAB) comprising;
a) MnCo₂O₄/NEGF electrocatalyst coated on gas diffusion layer (GDL) in an air cathode;
b) an anode; and
c) an electrolyte placed between the air cathode and anode; wherein, the NEGF and GDL interact at the reactive interface of the air cathode delivering a higher power density with stable cyclic stability of ZAB.

The anode material is Zinc material, which is more abundant, cheap, and non-toxic.

The electrolyte material is selected from polyvinyl alcohol (PVA), potassium hydroxide (KOH), and the combination of PVA-KOH gel, where said materials are cheap and easily polymerized to fabricate in the ZAB device.

The catalyst slurry was brush-coated over a gas diffusion layer (GDL) and was dried at 60° C. for 12 h to achieve a catalyst loading of 1.0 mg cm⁻² (electrode area=1.0 cm²). A VMP-3 model Bio-Logic Potentiostat/Galvanostat was used to evaluate the ZAB set-up at room temperature.

### BRIEF DESCRIPTION OF THE ACCOMPANYING DRAWINGS

FIG. 1: shows (a) the FESEM images of MnCo₂O₄/NEGF, displaying the porous architecture of the entangled 3D graphene sheets; (b) magnified FESEM image of MnCo₂O₄/NEGF; (c) 3D micro-CT images of MnCo₂O₄/NEGF, showing the porous structure of 2D sheets are connected; (d) TEM image of MnCo₂O₄/NEGF, shows the uniform distribution of MnCo₂O₄ over the N-doped of 3D graphene; (e) HRTEM image of MnCo₂O₄/NEGF, clearly shows the d-spacing for MnCo₂O₄, Inset showing the crystal nature of MnCo₂O₄. (f-k) elemental mapping for Co, Mn, N, O and C respectively.

FIG. 2: (a) shows the comparative pore size distribution of NEGF, MnCo₂O₄, and MnCo₂O₄/NEGF materials; (b) Comparative BET adsorption and desorption isotherm of NEGF, and MnCo₂O₄/NEGF, showing type-IV isotherm.

FIG. 3: (a) XPS analysis of MnCo₂O₄/NEGF; (a) comparative survey scan spectra of NEGF, Co₃O₄/NEGF, and MnCo₂O₄/NEGF showing the presence of C, N, O, Co, and Mn in the respective catalysts; (b) deconvoluted spectra of Co2p showing presence of two spin-spin splitting peaks reveals the +2 and +3 oxidation state of Co in MnCo₂O₄/NEGF; (c) deconvolutes Mn spectra, shows two peaks corresponding two oxidation state of Mn, +2 and +3; (d) deconvoluted N1s spectra, confirm the presence of four types of nitrogen;

FIG. 4: Electrocatalytic RDE performance analysis of NEGF, Co₃O₄/NEGF, Mn₃O₄/NEGF, and MnCo₂O₄/NEGF towards ORR and OER in comparison to the state-of-the-art (Pt/C) and RuO₂ catalyst respectively; (a) comparable LSV profiles for NEGF, Co₃O₄/NEGF, MnCo₂O₄/NEGF, and Pt/C in O₂ sat 0.1 M KOH recorded at an RPM of 1600 of the WE displaying the onset potentials at 1.0, 0.94, 0.80 and 0.65 mV, respectively, with respect to RHE; (b) comparable LSV profiles for NEGF, Co₃O₄/NEGF, MnCo₂O₄/NEGF, and Pt/C in O₂ sat 0.1 M KOH recorded at an RPM of 1600 of the WE displaying the onset potentials at 1.0, 0.94, 0.80 and 0.65 mV, respectively, with respect to RHE; (c) comparable bifunctional activity LSV profiles of NEGF, Co₃O₄/NEGF, Mn₃O₄/NEGF, and MnCo₂O₄/NEGF displaying the onset potentials at 1.0, 0.94, 0.80 and 0.65 mV, respectively, with respect to RHE; (d) Comparative onset, half-wave potential and bifunctional activity for NEGF, Co₃O₄/NEGF, Mn₃O₄/NEGF, and MnCo₂O₄/NEGF; (e) Tafel plot analysis for NEGF, Co₃O₄/NEGF, Mn₃O₄/NEGF, and MnCo₂O₄/NEGF for ORR activity; (f) Tafel plot analysis for NEGF, Co₃O₄/NEGF, Mn₃O₄/NEGF, and MnCo₂O₄/NEGF for OER activity.

FIG. 5. FIG. 5a and the inset image show the cross-sectional FESEM image of the bare GDL. GDL coated with MnCo₂O₄/NEGF (FIG. 6b). The inset of Figure FIG. 5b gives better clarity of the surface containing the 3D self-assembled structure of the coated layer of MnCo₂O₄/NEGF. FIGS. 5c and d show the 3D tomogram cross-section images of the bare GDL and the MnCo₂O₄/NEGF-coated GDL, respectively. The MnCo₂O₄/NEGF-coated surface of the GDL shows a water contact angle of 109.2° (FIG. 6f). The CA data corresponding to the base GDL is presented in FIG. 6e.

FIG. 6: All-solid-state rechargeable zinc-air battery (ZAB) performance evaluation for MnCo₂O₄/NEGF and Pt/C+RuO₂ as the air electrodes: (a) polarization plots recorded on the ZABs fabricated by employing MnCo₂O₄/NEGF and Pt/C+RuO₂ as the air electrodes; (b) comparative impedance plot recorded for ZAB set-up constructed with MnCo₂O₄/NEGF and Pt/C+RuO₂ as the air electrodes; (c) galvanostatic charge-discharge plot for MnCo₂O₄/NEGF and Pt/C+RuO₂, shows the higher potential window for Pt/C+RuO₂ compared to MnCo₂O₄/NEGF; (d) the galvanostatic charge-discharge cycling curves at 10 mA cm⁻², shows in case of Pt/C+RuO₂, asymmetric charge-discharge plateau (e) galvanostatic discharge capacity of the battery at the various current density of 5, 10,20, 30 mA cm⁻².

FIG. 7 provides schematic illustration of the stages involved in the stepwise synthesis of MnCo₂O₄/NEGF as an ORR/OER bifunctional electrocatalyst, and demonstration of its application as the air-electrode for the Solid-State Rechargeable Zn-Air Battery.

FIG. 8 shows illustrative of claimed all solid-state rechargeable Zn-air battery set up.

### DETAILED DESCRIPTION OF THE INVENTION

The invention will now be described in detail in connection with certain preferred and optional embodiments, so that various aspects thereof may be more fully understood and appreciated.

In an embodiment, the present invention discloses a bifunctional electrocatalyst for bifunctional oxygen reaction at air cathode interface comprising manganese-cobalt-based bimetallic spinel oxide deposited on N-doped 3D porous graphene (NEGF).

In a preferred embodiment, the present invention relates to MnCo₂O₄/3D NGr electrocatalyst which represents the self-assembly structure of nitrogen-doped three-dimensionally oriented graphene. The MnCo₂O₄ is uniformly distributed over the N-doped 3D graphene.

In another embodiment, the electrocatalysts (MnCo₂O₄/3D NGr) as air cathode material is prepared by solvothermal process comprising;
(i) dispersing the graphene oxide (GO) synthesized via improved Hummer's method in water and ammonia solution (30% v/v) to obtain viscous graphene oxide solution;
(ii) adding Co²⁺ and Mn²⁺ metal salts to the viscous graphene oxide solution of step (i) in 2:1 ratio at constant stirring followed by probe sonication;
(iii) transferring the solution of step (ii) to a Teflon-lined autoclave and heating followed by cooling and washing to remove excess ammonia;
(iv) freeze-drying the mixture of step (iii) under high vacuum pressure to obtain the desired catalyst.

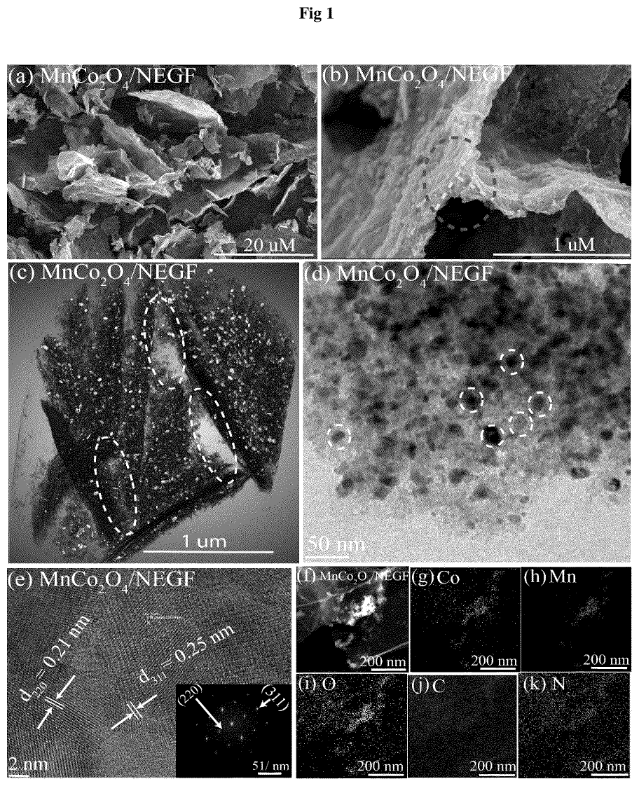

The Freeze-drying of hydrothermally treated catalytic material is a crucial step that induces the homogeneous porosity to the N-doped reduced graphene oxide which is clearly evidenced in the FESEM (field emission scanning electron microscopy) images (FIGS. 1a and 1b).

In still another embodiment, the pore size of MnCo₂O₄/NEGF catalytic material ranges between 2-16 nm; has a BET surface area in the range of 300-320 m²g⁻¹.

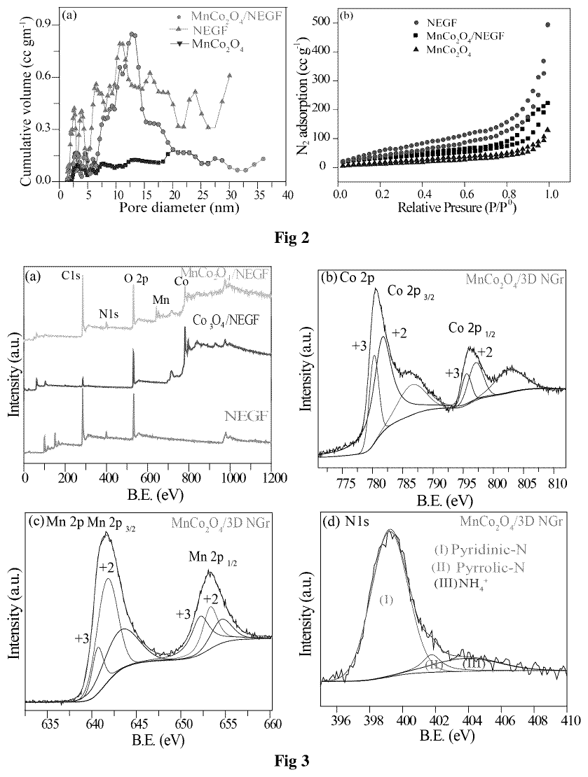

The XRD pattern (FIG. 2b) of MnCo₂O₄/NEGF discloses a series of peaks at 2θ=18.3, 30.2, 35.6, 37.0, 43.2, 53.8, 57.2, 62.7 and 74.0°, which are ascribed to (111), (220), (311), (400), (422), (511), (440) and (533) diffraction peaks corresponding to the spinel structure MnCo₂O₄. After incorporating spherical shaped MnCo₂O₄ over NEGF, a graphitic (002) plane shift towards a lower diffraction angle compared to the NEGF is observed is ascribed to the increasing the d-spacing of the nitrogen-doped graphene sheets.

The extent of the defects to the graphitic nature of the employed conducting support is measured by calculating the I_{D}/I_{G} ratio using Raman spectroscopy analysis. In the Raman spectra, the D-band expresses the defects in the graphene lattice structure, and the G band represents the orderliness in the graphene. The D-band peak that appeared at 1350 cm⁻¹ corresponds to the graphitic lattice vibration mode with the A_{1g} symmetry, while the G-band peak appeared at 1590 cm⁻¹ corresponds to the E_{2g} symmetry graphitic lattice vibration mode. Raman spectra of NEGF, and MnCo₂O₄/NEGF catalyst with the I_{D}/I_{G} values of 1.25, and 1.31, respectively. The increased I_{D}/I_{G} value from GO (˜1.0) to NEGF catalyst clearly indicates the creation of new defect sites with the introduction of doped nitrogen into the graphitic lattice structure through solvothermal treatments at 180° C. The introduced defective sites in the N-doped graphene sheets are helpful for metal oxides nucleation. The defective sites are higher in MnCo₂O₄/NEGF than its counterpart NEGF support which must have been introduced during the in-situ growth of metal oxides. The higher defective sites observed in the case of metal oxides supported NEGF stand out to assist the system towards catalytic activity enhancement. The total loading of the spinel oxide active site, which suppresses the BET surface area in MnCo₂O₄/NEGF, was determined by the thermogravimetric analysis (TGA). TGA was done under an oxygen atmosphere in the temperature range of 25 to 900° C. at a scan rate of 10° C. per minute. TGA weight loss profile for MnCo₂O₄/NEGF, indicating the MnCo₂O₄ loading of ˜45 wt. % over the nitrogen-doped carbon. The observed higher loading of MnCo₂O₄ nanoparticles suppresses the overall surface area of the prepared MnCo₂O₄/NEGF catalyst to 300 m2g−m1 m2 g⁻¹. The achieved higher loading of MnCo₂O₄ (45%) over conducting support maintains the overall conductivity and active sites density of the catalyst required for better electrochemical activity.

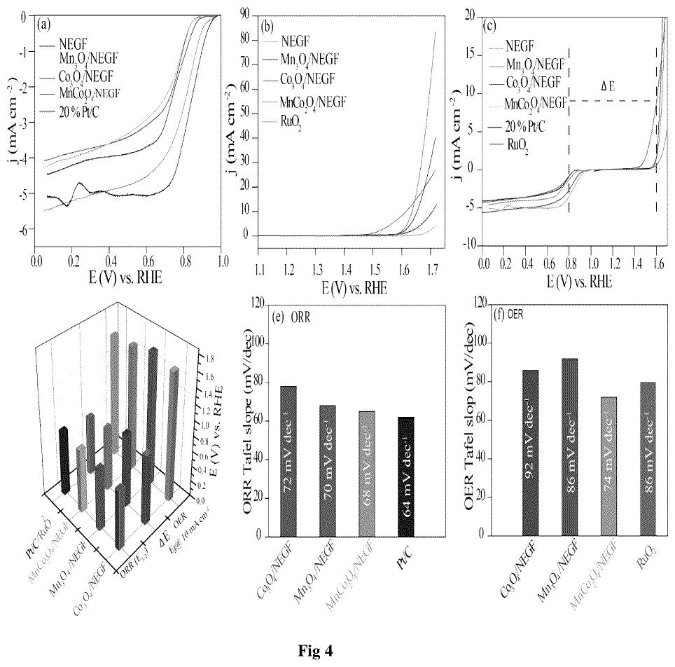

In a further embodiment, the electrochemical ORR and OER performance was measured using an aqueous solution of 0.1 M KOH and 1 M KOH respectively. The intrinsic ORR activity of the catalysts was measured by linear sweep voltammetry (LSV) analysis in 0.1 M KOH at the scan rate of 10 mV sec⁻¹ under O₂ atmosphere to maintain the working electrode rotation at 1600 RPM. The comparative LSV profile (FIG. 4a) evidences the superior ORR performance achieved by MnCo₂O₄/NEGF compared to the control samples, i.e., NEGF (0.86 V), Co₃O₄/NEGF (0.89 V), and Mn₃O₄/NEGF (0.85 V). In addition, the ORR performance of MnCo₂O₄/NEGF (0.93 V) is observed close to state-of-the-art catalysts (Pt/C), showing its higher catalytic potential (0.99 V). Similarly, the OER activity was for NEGF, Co₃O₄/NEGF, Mn₃O₄/NEGF, MnCo₂O₄/NEGF, and RuO₂ in 1 M KOH at a scan rate of 10 mV sec⁻¹ under N₂ atmosphere. The LSVs recorded for MnCo₂O₄/NEGF (FIG. 4b) showed better electrochemical OER activity compared to NEGF, Co₃O₄/NEGF, and Mn₃O₄/NEGF. The superior performance of MnCo₂O₄/NEGF catalyst towards both oxygen reactions (ORR/OER) is observed in LSV analysis. The overall bifunctional activity (ORR-OER) of MnCo₂O₄/NEGF is found to be 0.82 V which is comparable or better than previously reported various bifunctional electrocatalysts (Table 1). The observed higher bifunctional oxygen reaction activity of the prepared catalyst is attributed to the bimetallic composite of Mn and Co spinel oxides and nitrogen doped 3D carbon support providing effective TPB formation for better mass transport properties.

TABLE 1
Comparison of the bifunctional oxygen activity of the non-noble metal-
based electrocatalysts and electrocatalyst of present invention.

| | Half Wave | | | |
|---|---|---|---|---|
| | Potential | Ej@10 mA | Bifunctional | |
| | E½ (V) | cm−2 | activity ΔE | |
| Electrocatalysts | vs. RHE | (V vs. RHE) | (mV) | References |
| Co₃O₄/NPGC | 0.84 | 1.68 | 0.84 | Dr. Ge Li et |
| | | | | al., 2016 |
| Co/N—C-800 | 0.74 | 1.60 | 0.86 | Qian Lu et al., |
| | | | | 2019 |
| Co₃O₄/CNW | 0.76 | 1.57 | 0.83 | Siyang Liu et |
| | | | | al., 2015 |
| CoMn₂O_{4/}NGr | 0.80 | 1.66 | 0.86 | Moni Prabu et |
| | | | | al., 2014 |
| Manganese - | 0.88 | 1.68 | 0.80 | Yongye Liang |
| Cobalt Oxide | | | | et al., 2012 |
| and Graphene | | | | |
| MnCo₂O₄ - | 0.78 | 1.65 | 0.87 | Li Xu et al., |
| graphene | | | | 2012 |
| MnCo₂O₄/ | 0.81 | 1.63 | 0.82 | Present Work |
| NEGF | | | | |

From table 1, it is evident that lower E_{1/2} value means better activity; higher Ej higher means the improved limiting current; and lower ΔE value means the better bifunctional activity for catalysts of present application.

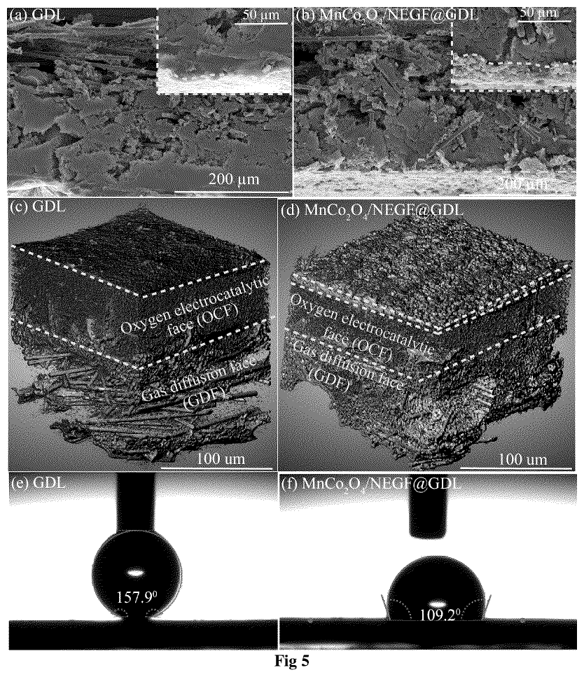

In another embodiment, the MnCo₂O₄/NEGF catalyst of the present invention is stable up to 5000 cycles evidenced by the cyclic durability study (FIG. 5a-c).

In another preferred embodiment, the present invention relates to all-solid state rechargeable zinc air battery (ZAB) comprising;
a) MnCo₂O₄/NEGF electrocatalyst coated on gas diffusion layer (GDL) in an air-cathode;
b) an anode; and
c) an electrolyte placed between the air cathode and anode; wherein, the NEGF and GDL interact at the reactive interface of the air cathode delivering a higher power density with stable cyclic stability of ZAB.

In still another embodiment, the anode material is Zinc material, which is more abundant, cheap, and non-toxic.

In yet another embodiment, the electrolyte material is selected from polyvinyl alcohol (PVA), potassium hydroxide (KOH), and the combination of PVA-KOH gel, where said materials are cheap and easily polymerized to fabricate in the ZAB device.

In still another embodiment, the gel electrolyte for all-solid-state rechargeable zinc-air battery (ZAB) is prepared by the process comprising:
(i) dissolving PVA powder in ultrapure water and agitating vigorously at a temperature ranging between 80-100° C. until a translucent gel solution is formed; and
(ii) adding a base to the above solution drop wise at the same temperature and storing in the refrigerator to obtain the desired product.

In yet another embodiment, the catalyst slurry of MnCo₂O₄/NEGF for coating on to the GDL electrode is prepared by the process comprising:
(i) adding MnCo₂O₄NEGF to the mixture of IPA and water (1:4) and sonicating;
(ii) adding 10 wt % Fumion solution to the dispersion of step (i) and sonicating until complete dispersion is obtained; and
(iii) coating the catalyst slurry over the gas diffusion layer (GDL) and drying to achieve a catalyst loading of 1.0 mg cm⁻².

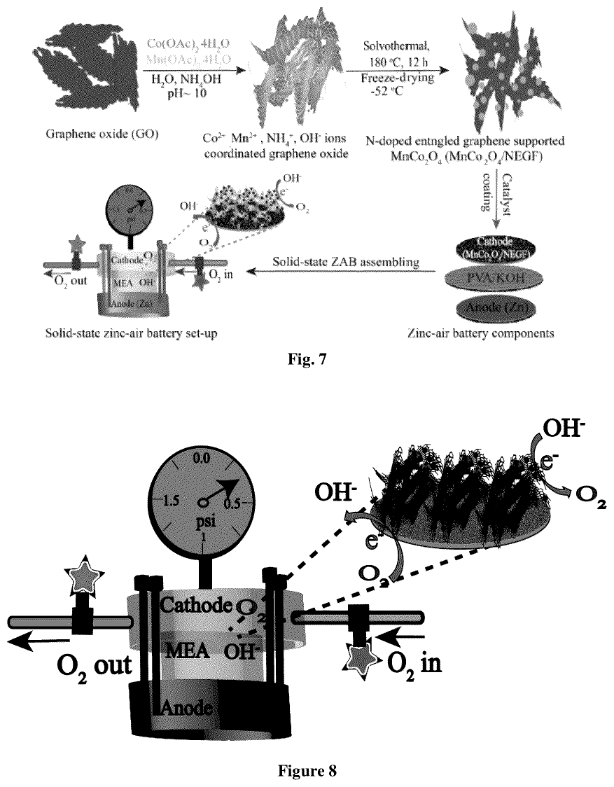

FIG. 7 depicts a simplified illustration of the stages involved in the stepwise synthesis of MnCo₂O₄/NEGF as an ORR/OER bifunctional electrocatalyst and demonstration of its application as the air-electrode material for the rechargeable ZAB. In brevity, the aqueous solution of the graphene oxide (GO) synthesized via the improved Hummer's method was mixed well with Co²⁺ and Mn²⁺ metal precursors (2:1) at constant stirring for 6 h. Ammonium hydroxide (˜30% v/v) was added to the metal ion-anchored GO solution with continuous stirring for 6 h, followed by probe sonication for 10 min. Depending on the nature of the functional groups present in the GO and the binding strength of carbon-carbon bonds, the doped nitrogen exists in various forms such as pyrrolic, pyridine, graphitic, and quaternary states. This creates asymmetric carbon centers with some differences in the electronegativity in the system. At high temperatures and pressure of the solvothermal treatment, the metal hydroxides gradually decompose and nucleate at the asymmetric carbon centers, resulting in the formation of the spherically shaped spinel oxide (MnCo₂O₄) nanoparticles anchored over the N-doped reduced graphene oxide's surface. The solvothermal reaction is followed by the freeze-drying process, which plays an important aspect in establishing the 3D geometrical orientation and restructuring of the graphene sheets bearing the bimetallic spinel oxide nanoparticles. This electrocatalyst consisting of the entangled graphene framework with homogeneously dispersed Co—Mn spinel oxide nanoparticles (MnCo₂O₄/NEGF) possesses a high surface area and catalytic site-accessible porous architecture. The resulting catalyst was coated over a porous carbon gas diffusion layer (GDL) in combination with PVA-KOH gel electrolyte, and a solid-state rechargeable ZAB device was fabricated and demonstrated.

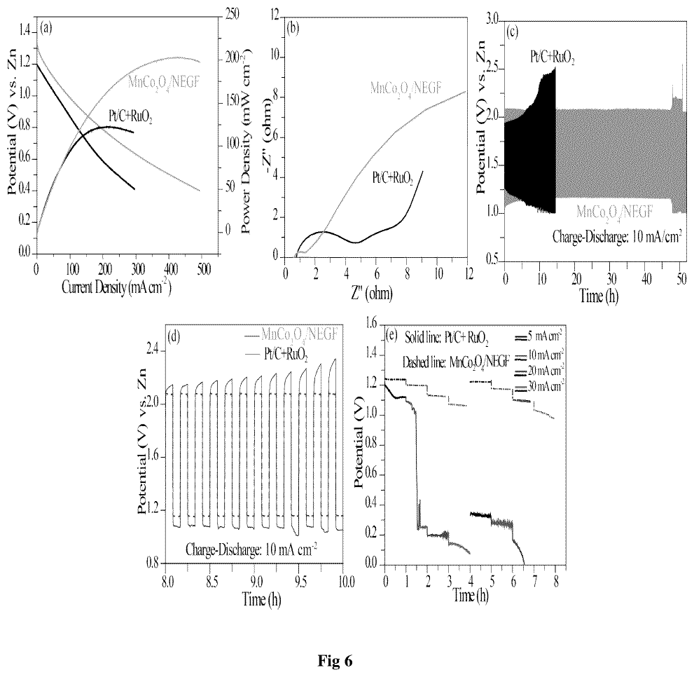

In another embodiment, the performance of all-solid-state rechargeable ZAB is shown in FIG. 6(a-e), with the open-circuit voltage (OCV) values of 1.31 and 1.20 V, respectively, for MnCo₂O₄/NEGF and Pt/C+RuO₂ coated electrodes. The comparative steady-state cell polarization leads to the maximum power density (Pₘₐₓ) of 110 and 200 mW cm⁻² for the ZABs based on Pt/C+RuO₂ and MnCo₂O₄/NEGF, respectively. The cathode catalysts show superior performance for the prepared catalyst (MnCo₂O₄/NEGF) compared to Pt/C+RuO₂, which is ascribed to be better interface formation in the former catalyst. Galvanostatic charge/discharge curve measured at 10 mA cm⁻² is shown in FIG. 6c. The observed difference between the charging and discharging voltages of ZAB on MnCo₂O₄/NEGF during the initial process was 0.84 V which was lower than 0.91 V of the Pt/C+RuO₂. After 50 h of continuous charge-discharge cycles, a nominal voltage difference increased by 0.10 V on ZAB consisting of MnCo₂O₄/NEGF compared to 1.1 V after 15 h cycle operation on Pt/C+RuO₂ ZAB. Moreover, the magnified image shows (FIG. 6d) that in case of MnCo₂O₄/NEGF, charge-discharge voltage plateau are more symmetric but in the case of Pt/C+RuO₂ deficient asymmetric charge-discharge curve is observed. This feature reveals the better bifunctional activity at ZAB air cathode interface in case of MnCo₂O₄/NEGF compared to Pt/C+RuO₂.

The application of MnCo₂O₄/NEGF as an air electrode to function in the discharging (ORR) and charging (OER) modes for a solid-state ZAB was demonstrated by employing the catalyst-coated gas diffusion electrode (GDE) as the cathode. Prior to the fabrication of the cell and its testing, the catalyst-coated GDL surface was characterized by using FESEM and X-ray CT mapping to check the 3D microstructure of the resulting electrodes (FIG. 6a-d). FIG. 6a and the inset image show the cross-sectional FESEM image of the bare GDL, revealing the mostly flat structure of the surface. However, in the case of the GDL coated with MnCo₂O₄/NEGF, a thick layer with 3D structure (indicated by the dotted yellow lines) is observed (FIG. 6b). The inset of FIG. 6b gives better clarity of the surface of the GDL containing the 3D self-assembled structure of the coated layer of MnCo₂O₄/NEGF. This 3D microstructured catalyst layer over the GDL has a significant advantage for achieving improved TPB with better active interface and mass transfer characteristics. The 3D CT tomography imaging of the commercial bare GDL consists of two parts (indicated by the dotted yellow lines in FIGS. 6c and 6d, i.e., the oxygen catalytic face (OCF) and the gas diffusion face (GDF) towards the inner and outer side of the air-electrode, respectively. At OCF, the carbon fibers are coated with the hydrophobic PTFE, which prevents the flooding of the microporous surface of the GDL. FIGS. 6c and 6d show the 3D tomogram cross-section images of the bare GDL and the MnCo₂O₄/NEGF-coated GDL, respectively. The tomography image in FIG. 6c shows the two distinct phases of OCF and GDF (marked with the dotted yellow lines) of the GDL as already indicated in the FESEM image of the corresponding sample presented in FIG. 6a. On the other hand, in the case of the 3D CT image of the catalyst-coated GDL (FIG. 6d), the 3D microstructure formation of the layer of MnCo₂O₄/NEGF is clearly evident and is demarcated with the dotted yellow line.

The 3D porous morphology of the MnCo₂O₄/NEGF layer in the electrode is beneficial for improving the electrode-electrolyte interface formation. However, to realize this advantage significantly, the porous layer also should retain the optimum intrinsic wettability of the electrocatalyst even after it was subjected to the coating protocol during the electrode fabrication process. Surprisingly, the MnCo₂O₄/NEGF-coated surface of the GDL shows a water contact angle of 109.2° (FIG. 6f). CA data corresponding to base GDL is presented in FIG. 6e. From these results, it is readily inferred that while aqueous electrolyte hardly wet bare GDL, GDL based on MnCo₂O₄/NEGF coating possesses balanced hydrophilic/hydrophobic characteristic, which is expected to result in optimum wettability at interface.

The ORR process is more sensitive to the TPB (triple phase boundary) interface during the discharge process than the OER reaction. The discharge curve at various current densities 5, 10, 20, and 30 mA cm⁻² were recorded for MnCo₂O₄/NEGF and Pt/C+RuO₂ catalysts for 1 h. When the current density was increased from 5.0 to 10.0 mA cm⁻², the charge voltage with the MnCo₂O₄/NEGF cathode decreased from 1.25 to 1.24 V. However; it decreased significantly from 1.1 to 0.2 V with the Pt/C+RuO₂. Even at 30.0 mA cm², the former has a charge voltage of 1.10 V, which is about 210 mV higher than the Pt/C+RuO₂. The ZAB based on a 3D nitrogen-doped containing catalyst has a relatively small voltage gap of 0.11, 0.12, 0.13, and 0.15 V at 5.0, 10.0, 20.0, and 30.0 mA cm−2. However, the ZAB with Pt/C+RuO₂ catalyst are 1.05, 0.14, 0.15, and 0.60 V, respectively. Even in the case of Pt/C+RuO₂ at a higher current density of 10 mA cm⁻² sudden drop of potential is observed. The catalyst (MnCo₂O₄/NEGF) coated air cathode benefits more from its higher ORR kinetics at the ZAB interfaces showing the vast advantage of the 3D porous architecture in terms of better oxygen gas transport and kinetics. Furthermore, the galvanostatic discharge curve recorded for MnCo₂O₄/NEGF and Pt/C+RuO₂ at 10 mA cm⁻² catalyst has a discharge time of about 48 h and 40 h, respectively. Hence, in the longer run, the MnCo₂O₄/NEGF catalyst is observed to outperform the Pt/C+RuO₂ system both in terms of performance and long-term durability under a realistic ZAB system.

In a nutshell, the present invention provides electrode material consisting of manganese-cobalt-based bimetallic spinel oxide (MnCo₂O₄)-supported nitrogen-doped entangled graphene (MnCo₂O₄/NEGF) with multiple active sites responsible for facilitating both OER and ORR has been prepared. The porous 3D graphitic support significantly affects the bifunctional oxygen reaction kinetics and helps the system display a remarkable catalytic performance. The air electrode consisting of the MnCo₂O₄/NEGF catalyst coated over the gas diffusion layer (GDL) ensures the effective TPB, and this feature works in favor of the rechargeable ZAB system under the charging and discharging modes. As an important structural and functional attribute of the electrocatalyst, the porosity and nitrogen doping in the 3D conducting support play a decisive aspect in controlling the surface wettability (hydrophilicity/hydrophobicity) of the air electrode. The fabricated solid-state rechargeable ZAB device with developed electrode displayed a maximum peak power density of 202 mW cm−2, which is significantly improved as compared to one based on Pt/C+RuO2 standard catalyst pair(124 mWcm−2). Solid-state device displaying an initial charge—discharge voltage gap of only 0.7 V at 10 mA cm−2 showed only small increment of 86 mV after 50 h.

### EXAMPLES

The following examples are given by way of illustration only and therefore should not be construed to limit the scope of the present invention in any manner.

Materials: Graphite, potassium permanganate (KMnO₄), manganese acetate tetrahydrate [Mn(OAC)₂·4H₂O], cobalt acetate tetrahydrate [Co(OAc)₂·4H₂O], ammonium hydroxide (NH₄OH), zinc acetate and potassium hydroxides were purchased from Sigma-Aldrich. Sulphuric acid (H₂SO₄) and phosphoric acid (H₃PO₄) were acquired from Thomas Baker. All the chemicals were used as such without any further purification.

### Example 1

(a) Synthesis of Graphene Oxide (GO): An improved Hummer's method was employed to synthesize graphene oxide (GO). Firstly, (1:6) graphite powder and KMnO₄ were well mixed using a mortar and pestle. The resulting solid mixture was slowly added to the round bottom flask containing a mixture of H₃PO₄:H₂SO₄ (1:9) solution kept in the ice bath. After complete transfer of solid mixture, the reaction solution was kept on stirring for 12 h at a constant temperature of 60° C. After the reaction was completed, the mixture was allowed to cool to room temperature. The resultant product was slowly poured into ice-cold water containing 3% H₂O₂ resulting in a yellowish solution. The resulting solution was then rinsed several times with a copious amount of distilled water followed by centrifugation at 10000 rpm. The collected residue solid was washed with 30 percent HCl to remove any metal impurities, then washed with plenty of water to neutralize the acidic pH and wash away the impurities. Finally, the dark chocolate-colored, highly viscous solution was collected and cleaned with ethanol and diethyl ether before drying at 40° C. to produce GO powder.

(b) Synthesis of MnCo₂O₄ Supported N-doped entangled 3D Graphene (MnCo₂O₄/NEGF): The as-prepared GO (example 1a) was dispersed in water (3 mg/ml) via overnight stirring and water-bath sonication. After the complete dispersion of GO in water, ammonia solution (30% v/v) was added and kept for constant stirring. After the formation of highly viscous graphene oxides solution, Mn(OAc)₂·4H₂O and Co(OAc)₂·4H₂O was added to the solution with a 1:2 ratio, and kept stirring for another 6 h followed by sonication by using probe sonication. After the metal ions had been thoroughly mixed, the reaction mixture was transferred to a Teflon-lined autoclave and heated at 180° C. for 12 hours. After that, the autoclave was allowed to cool and the sample was washed with water 5-6 times to remove the excess ammonia. The resulting reaction mixture was then freeze-dried for 10 h at −52° C. under high vacuum pressure. The sample was taken after the freeze-drying procedure was completed, and it had a black color flaky structure. The obtained sample was named as MnCo₂O₄/NEGF. For comparison, the controlled samples such as N-doped entangled graphene (NEGF), Mn₃O₄ supported N-doped entangled 3D graphene (Mn₃O₄/NEGF), and Co₃O₄ supported N-doped entangled 3D graphene (Co₃O₄/NEGF) was also synthesized. The NEGF, Mn₃O₄/NEGF, Co₃O₄/NEGF was prepared by using the same methods without adding any metal precursor and graphene oxide, with the addition Co(OAc)₂·4H₂O, Mn(OAc)₂·4H₂O respectively, keeping all the other parameters as such.

(c) Preparation of physically mixed composite of MnCo2O4 and N-doped Entangled 3D Graphene (MnCo2O4@NEGF): To prepare the physically mixed composite of MnCo2O₄ and NEGF, 100 mg of the as-prepared NEGF and 50 mg of MnCo2O₄ were mixed with the help of a mortar and pestle.

### Example 2: Physical Characterization

a) Field emission scanning electron microscopy (FESEM) analysis: FIG. 1(a) shows the FESEM image of the MnCo₂O₄/NEGF, which represents the self-assembly structure of nitrogen-doped three-dimensionally oriented graphene. The magnified image of MnCo₂O₄/3D NGr shown in FIG. 1(b) indicates the interconnected two-dimensional nitrogen-doped graphene. FIG. 1 (c) depicts 3D micro-CT images of MnCo2O4/NEGF, showing the porous structure of 2D sheets are connected.

b) Transmission electron microscopy (TEM) imaging: Transmission electron microscopy (TEM) imaging was performed to visualize the distribution of MnCo₂O₄ nanoparticles over 3D NEGF support (FIG. 1d). The TEM analysis shows that the spherical-shaped MnCo₂O₄ nanocrystals are uniformly distributed over individual sheets of N-doped graphene. The controlled distribution of the metal oxide nanoparticles is credited to the doped-N in the graphene sheets, which generates asymmetric carbon centers helping in the creation of homogeneous nucleation sites for growth of metal oxide nanoparticles. A fraction of metal oxide nanoparticles are distributed at the inner surface of 3D graphene, which are protected by the thin layer of graphene sheets providing better stability and preventing the chances of self-agglomeration of nanoparticles. The size of the spherical nanoparticles is distributed mostly in the range of 30-60 nm. FIG. 1(e) shows the high-resolution transmission electron microscopy (HRTEM), elucidating that the metal oxides are crystalline in nature. The metal oxide nanoparticles are having lattice fringe widths of d-spacing 0.25 and 0.21 nm, which is ascribed to the (311) and (211) facets suggesting the formation of cubic MnCo₂O₄ spinel phase. The selected area electron diffraction (SAED) pattern shown in FIG. 1(f-k), is the elemental mapping of the MnCo₂O₄/3D NGr catalyst. Elemental mapping exhibits presence and distribution of Co, Mn, O, C, and N, which is in line with the chosen composition of the catalyst. The presence of elemental cobalt and manganese in same positions with almost double intensity of cobalt clearly supports bimetallic structured Co and Mn formation.

c) Pore size: FIG. 2(a) shows the comparative pore size distribution of NEGF, MnCo₂O₄, and MnCo₂O₄/NEGF materials where the pores are distributed in the region of 2-20 nm for NEGF and 2-16 nm for MnCo₂O₄/NEGF. However, MnCo₂O₄ showed a significantly lower pore size distribution. The significantly suppressed pore size in the case of CoMn₂O₄/NEGF catalyst is in the range of 16-20 nm is mostly due to the agglomerated nonporous structure of spinel oxides (MnCo₂O₄). The Type-IV isotherms were seen in both NEGF and MnCo₂O₄/NEGF, FIG. 2(b). Moreover, the higher BET surface area of NEGF (450 m² g⁻¹) confirms the highly porous nature of NEGF as observed in the FESEM and CT-tomography image analysis. A reduction in BET surface area of MnCo₂O₄/NEGF to 300 m²g⁻¹ showed that some of the metal oxide species are lying in the microspores obscuring porous surface. The large specific surface area of catalyst is beneficial towards establishment of effective TPB in catalysis process suitable for fabrication of air electrodes of rechargeable ZAB.

d) X-ray diffraction (XRD) analysis: X-ray diffraction (XRD) analysis of NEGF displays the broad diffraction peaks at 2θ values of 26° and 43° corresponding to the (002) and (100) graphitic diffraction planes, respectively. The absence of any metallic peaks in the spectra suggests the higher purity level of the prepared nitrogen-doped 3D graphene. The XRD pattern of Co₃O₄/NEGF showed a comparatively intense peak at 2θ values of 35° corresponds to (311) plan for Co₃O₄. However, after the incorporation of Mn into the spinel structure of Co₃O₄, the resulting MnCo₂O₄/NEGF showed almost similar peaks intensity with a small shift in the peak position. The XRD pattern of MnCo₂O₄/NEGF confirmed a series of peaks at 2θ=18.3, 30.2, 35.6, 37.0, 43.2, 53.8, 57.2, 62.7 and 74.0°, which was ascribed to (111), (220), (311), (400), (422), (511), (440) and (533) diffraction peaks corresponding to spinel structure MnCo2O4(JCPDS No.23-1237). After incorporating spherical shaped MnCo₂O₄ over NEGF, a graphitic (002) plane shift towards lower diffraction angle compared to NEGF has been observed. This is ascribed due to incorporation of spherical MnCo₂O₄ nanoparticles between graphene layers which increased d-spacing of nitrogen-doped graphene sheets.

e) X-ray photoelectron spectroscopy (XPS): X-ray photoelectron spectroscopy (XPS) measurements have been employed in FIG. 3 (a-d). The survey scan spectra of NEGF, Co₃O₄/NEGF, and MnCo₂O₄NEGF shown in the figure confirm the presence of Mn, Co, O, N, and C in the respective materials. The characteristic Co 2p XPS peaks corresponding to Co₃O₄/NEGF and MnCo₂O₄/NEGF appear at the binding energy (B.E.) value of 784.2 eV and 795.5 eV and 783.5 eV and 796.5 eV, respectively. The characteristic peak separation (˜15.84 eV) between two peaks remains the same for spinel oxides. However, the shift in the binding energy after incorporating Mn into the spinel oxides Co₃O₄ evidenced the formation of bimetallic (MnCo₂O₄) spinel oxides. The observed negative shift in the binding energy of MnCo₂O₄ compared to Co₃O₄ might be due to the charge transfer from Co to Mn. Furthermore, deconvoluted XPS spectra of Co 2p in MnCo₂O₄/NEGF showed two doublet peaks at the B.E. values of 783.1 and 798.8 eV with a band separation of ˜15.7 eV pointing towards the existence of the +2 and +3 oxidation states of Co. In addition, the deconvoluted Mn spectra shows the two spin-spin coupling peaks at the B.E. Values of 783.1 and 798.8 eV corresponding to the Mn 2p_{3/2} and Mn 2p_{1/2} states of Mn also confirm the existence of the +2 and +3 oxidation states. Moreover, the deconvoluted N 1s spectra of the MnCo₂O₄/NEGF displays the peaks at pyridinic-N at 398.6 eV and the pyrrolic-N at 399.7 eV as the major moieties along with smaller proportions from the graphitic-N at 400.5 eV and NH₄⁺ at 405.5 eV. The presence of nitrogen doping in the conducting support is mostly responsible for improving surface wettability of electrocatalysts, thereby enhancing electrocatalytic activity.

f) Wettability of the Electrocatalyst: Hydrophilicity and Hydrophobicity property is an important aspect to maintain the effective electrochemical triple phase boundary (TPB) during electrochemical process. The contact angle (CA) measurement was performed in FIG. 3e to check the surface wettability of MnCo₂O₄/EGF and MnCo₂O₄/NEGF catalysts. The lower contact angle value of 24° for MnCo₂O₄/EGF confirmed the higher hydrophilicity of the catalyst, which can easily wet the catalyst surface resulting in water flooding, thereby hindering the mass transfer due to excessive wettability of the surface. After N doping into the 3D structure of graphene, the contact angle value for MnCo₂O₄/NEGF reached to the value of 42°. Optimum contact angle value implies that appropriate hydrophilicity/hydrophobicity of catalytic material is more conducive to form the gas-liquid-solid TPBs during the electrochemical reaction.

### Example 3: Electrochemical Half-cell Studies

(a) Rotating Disk Electrode Study: The electrochemical analysis was done by a couple of electrochemical techniques such as voltammetry. Cyclic voltammetry (CV), linear sweep voltammetry (LSV) and impedance techniques were adopted. A rotating disc electrode (RDE) set-up (Pine Instrument) was employed for the LSV measurements. The electrochemical cell was made of a set-up of a three-electrode used with an SP-300 model BioLogic potentiostat. A glassy carbon electrode was used as the working electrode, whereas, a graphite rod (Alfa Aesar, 99.99%) and Hg/HgO were employed as the counter and reference electrodes, respectively. For the comparison of the ORR and OER performance of the prepared electrocatalyst in half-cell studies, we included the ORR activity of 20% Pt/C and the OER activity of RuO2. The catalyst slurry was prepared by mixing the catalyst (5 mg) in 1 mL isopropyl alcohol-water (3:2) solution and 40 μL of Nafion solution (5 wt %, Sigma-Aldrich) using approximately 1 h water-bath sonication. After that, 10 μL of the catalyst slurry was drop-coated on the surface of the working electrode, which was polished with 0.3 μm alumina slurry in DI water followed by cleaning with DI water and acetone. The electrode was then dried under an IR-lamp for 1 h. The experiment was carried out in an aqueous solution of 0.1 M KOH for ORR and 1 M KOH for OER performance measurements.

### (b) Solid-State ZAB Demonstration:

(b)-1: Preparation of the Gel Electrolytes: 2 g PVA powder (MW205000, Sigma-Aldrich) was typically dissolved in 16 mL ultrapure water at 90° C. with vigorous agitation. When a translucent gel solution is formed, 4 mL of 9 M KOH solution is added dropwise and the mixture is stirred for 20 min. at 90° C. The gel solution was put into a petri dish (2 cm in diameter), and then stored in the refrigerator at −20° C. for 1 h and then at 0° C. for another 1 hour. After that, a thin sheet structure of the gel electrolyte was formed, which was used as the electrolyte for the fabrication of the solid-state ZAB device.

(b)-2: Assembly and test of solid-state ZAB device: The solid-state rechargeable ZAB was assembled by utilizing Zn powder as the anode, MnCo2O4/NEGF-coated GDL as the air-cathode, and PVA/KOH gel as the electrolyte in an electrochemical ZAB device set up (MTI Corporation). For the preparation of the catalyst slurry, MnCo2O4/NEGF was added to the 1:4 ratio mixture of isopropyl alcohol and water followed by keeping for sonication for 1 h. To the resulting dispersion, 10 wt % Fumion solution was added, and the mixture was sonicated for an additional 1 h. After the complete dispersion, the catalyst slurry was brush-coated over a gas diffusion layer (GDL) and was dried at 60° C. for 12 h to achieve a catalyst loading of 1.0 mg cm⁻² (electrode area=1.0 cm²). A multichannel VMP-3 model Bio-Logic Potentiostat/Galvanostat was used to evaluate the ZAB set-up at room temperature. The ZAB was analyzed by steady-state polarization at a scan rate of 5 mV/s. The polarization analysis and EIS studies were performed at a constant voltage of 1.0 V with an amplitude of 20 mV; the galvanostatic discharge and discharge-charge cycling (5 min discharge followed by 5 min charge) tests were carried out by a Bio-Logic potentiostat.

(c) Electrocatalytic RDE performance analysis: The intrinsic ORR activity of the catalysts was measured by linear sweep voltammetry (LSV) analysis in 0.1 M KOH at the scan rate of 10 mV sec⁻¹ under O₂ atmosphere to maintain the working electrode rotation at 1600 RPM. The comparative LSV profile (FIG. 4a) evidences the superior ORR performance achieved by MnCo₂O₄/NEGF compared to the control samples, i.e., NEGF (0.86 V), Co₃O₄NEGF (0.89 V), and Mn₃O₄NEGF (0.85 V). In addition, the ORR performance of MnCo₂O₄/NEGF (0.93 V) is close to state-of-the-art catalysts (Pt/C), showing its higher catalytic potential (0.99 V). Similarly, the OER activity has also been measured for NEGF, Co₃O₄/NEGF, Mn₃O₄/NEGF, MnCo₂O₄/NEGF, and RuO₂ in 1 M KOH at a scan rate of 10 mV sec−1 under N₂ atmosphere (FIG. 4b). LSVs recorded for MnCo₂O₄NEGF showed better electrochemical OER activity compared to NEGF, Co₃O₄NEGF, and Mn₃O₄/NEGF. The superior performance of MnCo₂O₄NEGF catalyst towards both oxygen reactions (ORR/OER) is observed in LSV analysis. Moreover, differences in OER potential (Eⱼ@10 mA cm⁻²) and ORR half-wave potential (E_{1/2}) are generally used to evaluate the performance of bifunctional catalyst. Overall bifunctional activity (ORR-OER) of MnCo₂O₄/NEGF is 0.82 V (FIG. 4c), which is comparable or better than previously reported various bifunctional electrocatalyst. Observed higher bifunctional oxygen reaction activity of prepared catalyst is attributed to bimetallic composite of Mn and Co spinel oxides and nitrogen doped 3D carbon support providing effective triple phase boundary (TPB) formation for better mass transport properties.

### Example 4: Fabrication of All-solid-state ZAB Device

a) Preparation of Gel Electrolytes: 2 g PVA powder (MW205000, Sigma-Aldrich) was dissolved in 16 mL ultrapure water at 90° C. with vigorous agitation. When translucent gel solution was formed, 4 mL of 9 M KOH solution was added dropwise and stirred for 20 minutes at 90° C. The gel solution was put into a petri dish (2 cm in diameter), and stored in refrigerator at −20° C. for 1 hour and then at 0° C. for 1 hour. After that, thin sheet structure of gel electrolyte was formed and used as electrolyte for all-solid-state ZAB device fabrication.

b) All-solid-state ZAB Device: All-solid-state rechargeable ZAB was assembled by utilizing Zn powder as the anode, MnCo₂O₄/NEGF coated GDL as the air cathode electrodes, and PVA/KOH gel as an electrolyte, respectively, in an electrochemical ZAB device set up (MTI corporation) depicted in FIG. 11. For the preparation of catalyst slurry, MnCo₂O₄/NEGF was added to the mixture of (1:4) ratio isopropyl alcohol and water and kept for 1 hr sonication. To the resulting dispersion, 10 wt % Fumion solution was added, and the mixture was sonicated for an additional 1 hour. After the complete dispersion, the catalyst slurry was brush coated over the gas diffusion layer (GDL) and dried at 60° C. for 12 hours to achieve a catalyst loading of 1.0 mg cm−2 (electrode area=1.0 cm²). The ZAB was analyzed by steady-state polarization at a scan rate of 5 mV/s. The air electrode for all-solid-state ZAB contained a porous catalyst layer coated onto diffusion layer (GDL) with hydrophobic PTFE pointed on the air-facing side. A solution consisting of 6 M KOH and 0.1 MZn (Ac)₂ was added during the fabrication of PVA as gel electrolyte. The polarization analysis and EIS studies were performed at a constant voltage of 1.0 V with an amplitude of 20 mV; the galvanostatic discharge and discharge-charge cycling (5 min discharge followed by 5 min charge) tests were carried out by Bio-Logic potentiostat.

c) Characterization of ZAB Assembly: The application of MnCo₂O₄/NEGF as an air electrode to function in the discharging (ORR) and charging (OER) modes for a solid-state ZAB was demonstrated by employing the catalyst-coated gas diffusion electrode (GDE) as the cathode. Prior to the fabrication of the cell and its testing, the catalyst-coated GDL surface was characterized by using FESEM and X-ray CT mapping to check the 3D microstructure of the resulting electrodes (FIG. 6). FIG. 6a and the inset image show the cross-sectional FESEM image of the bare GDL, revealing the mostly flat structure of the surface. However, in the case of the GDL coated with MnCo₂O₄/NEGF, a thick layer with 3D structure (indicated by the dotted yellow lines) is observed (FIG. 6b). The inset of Figure FIG. 6b gives better clarity of the surface containing the 3D self-assembled structure of the coated layer of MnCo₂O₄/NEGF. Compared to the highly porous nature of the MnCo₂O₄/NEGF layer on the GDL, the catalyst layer of Pt/C+RuO₂ is found to be significantly less porous. Figure FIGS. 6c and d show the 3D tomogram cross-section images of the bare GDL and the MnCo₂O₄/NEGF-coated GDL, respectively.

d) Electrochemical performance of all-solid-state rechargeable ZAB device: FIG. 7(a-e) shows the performance of all-solid-state rechargeable ZAB with the open-circuit voltage (OCV) values of 1.31 and 1.20 V, respectively, for MnCo₂O₄/NEGF and Pt/C+RuO₂ coated electrodes. The comparative steady-state cell polarization leads to the maximum power density (Pₘₐₓ) of 110 and 200 mW cm⁻² for the ZABs based on Pt/C+RuO₂ and MnCo₂O₄/NEGF, respectively. The cathode catalysts show superior performance for the prepared catalyst (MnCo₂O₄/NEGF) compared to Pt/C+RuO₂, which is ascribed to be better interface formation in the former catalyst. The performance of the fabricated all-solid-state ZAB is comparable and even superior to some of the reported all-solid-state ZABs in the literature (Table 2). The Impedance spectra for all-solid-state ZABs are significantly different for MnCo₂O₄/NEGF and Pt/C+RuO₂, which might be due to better interface formation between the 3D porous structure of the electrocatalyst and GDL surface compared to the two-dimensional architecture of Pt/C+RuO2 catalyst. Furthermore, the galvanostatic charge/discharge curve measured at 10 mA cm⁻² is shown in FIG. 7c.

TABLE 2
Comparison of the performance of the solid-state ZAB systems
based on the non-precious metal-based electrocatalysts.

| | | | Power | | |
|---|---|---|---|---|---|
| | | | density | | |
| Electro- | | OCV | (mW | | |
| catalyst | Electrolyte | (V) | cm−2) | Stability | References |
| Co₃O₄-x | PVA-KOH | 1.46 | 94.1 | 50 cycles | Dongxiao Ji |
| HoNPs@HP | (Solid) | | | for 18 | et al., 2019 |
| NCS | | | | h @ 3 | |
| | | | | mA cm−2 | |
| Co/CoO/ | PVA-KOH | 1.32 | 28 | 36 h @ 2 | Xingyu Cui |
| NWC | (Solid) | | | mA cm−2 | et al., 2021 |
| CoN₄/NG | PVA-KOH | — | 28 | 6 h @ 1 | Liu Yang1 et |
| | (Solid) | | | mA cm−2 | al., 2018 |
| MnOx-GCC | PVA-KOH | 1.42 | 18 | 30 h @ | A. Sumboja |
| | (Solid) | | | 0.7 mA | et al., 2017 |
| | | | | cm−2 | |
| CoSx/ | PVA-KOH | 1.34 | — | 16 h @ 1 | Qian Lu et |
| Co—NC-800 | (Solid) | | | mA cm−2 | al., 2019 |
| MnCo₂O₄/ | PVA-KOH | 1.31 | 202 | 51 h | Present |
| NEGF | (Solid) | | | | work |

The observed difference between the charging and discharging voltages of ZAB on MnCo₂O₄/NEGF during the initial process was 0.84 V which was lower than 0.91 V of the Pt/C+RuO₂. After 50 h of continuous charge-discharge cycles, a nominal voltage difference increased by 0.10 V on ZAB consisting of MnCo₂O₄/NEGF compared to 1.1 V after 15 h cycle operation on Pt/C+RuO2 ZAB. The higher stability of MnCo₂O₄/NEGF based air cathode might be due to better air cathode interface formation via the porous and stable 3D structure of nitrogen-doped carbon. Moreover, the magnified image shows (FIG. 7d)NEGF-based that in the case of MnCo₂O₄/NEGF, the charge-discharge voltage plateau are more symmetric but in the case of Pt/C+RuO₂ deficient asymmetric charge-discharge curve. This feature reveals the better bifunctional activity at the ZAB air cathode interface in the case of MnCo₂O₄/NEGF compared to Pt/C+RuO₂.

The ORR process is more sensitive to the TPB interface during the discharge process than the OER reaction. Discharge curves for the ZABs at various current densities were collected to analyze the influence of the 3D microstructure on ORR kinetics at ZAB air cathode (FIG. 7e). So, the discharge curve at various current densities 5, 10, 20, and 30 mA cm⁻² were recorded for MnCo₂O₄/NEGF and Pt/C+RuO₂ catalysts for 1 h. When the current density was increased from 5.0 to 10.0 mA cm⁻², the charge voltage with the MnCo₂O₄/NEGF cathode decreased from 1.25 to 1.24 V. However; it decreased significantly from 1.1 to 0.2 V with the Pt/C+RuO₂. Even at 30.0 mA cm², the former has a charge voltage of 1.10 V, which is about 210 mV higher than the Pt/C+RuO₂. The ZAB based on a 3D nitrogen-doped containing catalyst has a relatively small voltage gap of 0.11, 0.12, 0.13, and 0.15 V at 5.0, 10.0, 20.0, and 30.0 mA cm−2. However, the ZAB with Pt/C+RuO2 catalyst are 1.05, 0.14, 0.15, and 0.60 V, respectively. Even in the case of Pt/C+RuO₂ at a higher current density of 10 mA cm⁻² sudden drop of potential is observed. The catalyst (MnCo₂O₄/NEGF) coated air cathode benefits more from its higher ORR kinetics at the ZAB interfaces showing the vast advantage of the 3D porous architecture in terms of better oxygen gas transport and kinetics. This demonstrates that these kinds of air cathode have outstanding application potential under high current density. Furthermore, the galvanostatic discharge curve recorded for MnCo₂O₄/NEGF and Pt/C+RuO₂ at 10 mA cm⁻² catalyst has a discharge time of about 48 h and 40 h, respectively. Hence, in the longer run, the MnCo₂O₄/NEGF catalyst is expected to outperform the Pt/C+RuO₂ system both in terms of performance and long-term durability under a realistic ZAB system. The remarkable high-performance of rechargeable all-solid-state ZAB is attributed to the suitable air cathode interface design, sufficient active sites, and efficient mass transfer properties of MnCo₂O₄/NEGF.

### Advantages of the Invention

3D porous architecture of N-doped graphene supported MnCo₂O₄ nanosphere viz. MnCo₂O₄/NEGF as an air cathode in all-solid-state Zinc-air batteries (ZABs).
Features like porous 3D architecture of the catalyst, balanced hydrophilic/hydrophobic characteristics, and optimal ORR/OER activity are found to be favorably helping the system as an air-electrode for the rechargeable ZAB application.
The 3D structure of the catalyst greatly helps the system in mass transfer and active site accessibility in the electrode. At the same time, the optimal hydrophilicity, originating from the functional attributes of the support surface, is found to play a significant role in constructing an effective interface for the catalyst and the electrolyte.
In terms of activity of MnCo₂O₄/NEGF toward said reactions, overpotential values are found closely comparable to respective state of art systems(Pt/C for ORR & RuO₂ for OER).
The demonstration of a solid-state rechargeable ZAB device with MnCo₂O₄/NEGF as the air electrode delivered a maximum peak power density of 200 mWcm⁻², with good stability at the time of the charge-discharge cycling process.
In terms of performance and charge-discharge cyclability, the system based on the homemade catalyst is found to have a clear upper hand compared to a system consisting of the state-of-the-art ORR/OER catalyst combination of Pt/C+RuO2.
The synergistic effect between MnCo₂O₄ nanoparticles and N-doped porous graphene promotes better interface formation (TPB). This benefits the system in terms of its bifunctional characteristics to perform as an effective electrocatalyst for facilitating both ORR and OER processes.
The established triple phase boundary (TPB) enhances the available reaction sites for gas and electrolyte solutions. Secondly, the electronic interaction between Co and Mn creates an appropriate adsorption site for O₂ and OH⁻ ions.
The N-doped porous graphene controls the optimum hydrophilicity, and hydrophobicity which helps to better wettability of the electrocatalyst.
The factors mentioned above collectively result in higher performance of electrocatalyst under the RDE condition and as an air cathode in ZABs.

We claim:

1. A bifunctional electrocatalyst, comprising:
a) a manganese-cobalt-based bimetallic spinel oxide (MnCo₂O₄), and
b) N-doped 3D porous entangled graphene (NEGF); wherein the MnCo₂O₄ is uniformly distributed over the self-assembled N-doped 3D porous entangled graphene; and said MnCo₂O₄/NEGF electrocatalyst is three-dimensional and porous.

2. The bifunctional electrocatalyst as claimed in claim 1, wherein the MnCo₂O₄ is present in the range of 60-70 wt. % and the NEGF is present in the range of 30-40 wt. % of total wt. % of the electrocatalyst.

3. The bifunctional electrocatalyst as claimed in claim 1, wherein the MnCo₂O₄ is spherical in shape with a size in the range of 30 to 60 nm.

4. The bifunctional electrocatalyst as claimed in claim 1, wherein the pore size is in the range of 2 to 16 nm and a BET surface area in the range of 300-320 m²g⁻¹.

5. A process for the synthesis of bifunctional electrocatalyst (MnCo₂O₄/NEGF) as claimed in claim1, via solvothermal process, comprising the steps of:
(i) preparing dispersed graphene oxide (GO) via improved Hummer's method, in water and ammonia solution (30% v/v) to obtain viscous graphene oxide solution;
(ii) adding Co²⁺ and Mn²⁺ metal salts to the viscous graphene oxide solution of step (i) in 2:1 ratio at constant stirring followed by probe sonication;
(iii) transferring the solution of step (ii) to a Teflon-lined autoclave and heating followed by cooling and washing to remove excess ammonia;
(iv) freeze-drying the mixture of step (iii) under high vacuum pressure to obtain the desired bifunctional electrocatalyst.

6. The process as claimed in claim 5, wherein the heating of step (iii) is done at a temperature in a range of 150 to 200 degree C. for a time period of 10 to 15 hr.

7. The process as claimed in claim 5, wherein the freeze drying of step (iv) is done at a temperature in a range of minus 50 to minus60 degree C. for a time period of 8 to 12 hr.

8. An all-solid-state rechargeable zinc-air battery (ZAB) comprising;
a) MnCo₂O₄/NEGF electrocatalyst as claimed in claim 1 coated on gas diffusion layer (GDL) in an air-cathode;
b) an anode; and
c) an electrolyte placed between the air cathode and anode; wherein, the NEGF and GDL interact at the reactive interface of the air cathode delivering a higher power density with stable cyclic stability of ZAB.

9. The all-solid-state rechargeable zinc-air battery (ZAB) as claimed in claim 8, wherein the anode material is Zinc material; and wherein the electrolyte material is selected from polyvinyl alcohol (PVA), potassium hydroxide (KOH) and a combination of PVA-KOH.

10. The all-solid-state rechargeable zinc-air battery (ZAB) as claimed in claim 8, wherein the catalyst slurry is brush-coated over a gas diffusion layer (GDL) and dried at 60° C. for 12 h to achieve a catalyst loading of 1.0 mg cm⁻² with electrode area of 1.0 cm².
